(19) United States
(12) Patent Application Publication
(10) Pub. No.: US 2014/0164089 A1
(43) Pub. Date: Jun. 12, 2014

(54) Reward Decision Engine

(71) Applicant: BANK OF AMERICA CORPORATION, Charlotte, NC (US)

(72) Inventors: David Joa, San Bruno, CA (US); Timothy J. Bendel, Charlotte, NC (US); Yanghong Shao, Charlotte, NC (US); Thayer S. Allison, JR., Charlotte, NC (US)

(73) Assignee: Bank of America Corporation, Charlotte, NC (US)

(21) Appl. No.: 13/708,601

(22) Filed: Dec. 7, 2012

(51) Int. Cl. G06Q 30/02

(52) U.S. Cl. CPC G06Q 30/0226
USPC 705/14.27

(57) ABSTRACT

A method of one embodiment facilitates the evaluation of reward choices. A plurality of reward parameters are received by an interface, each reward parameter associated with a user account of a user, and the plurality of reward parameters are stored by a memory. The interface receives information associated with a seller. A processor then automatically selects a user account based on the plurality of reward parameters and the information associated with the seller, and the interface communicates information indicating the selected user account.

### TECHNICAL FIELD OF THE INVENTION

The present invention relates generally to the field of customer transactions and more particularly to a reward decision engine.

### BACKGROUND OF THE INVENTION

Customers have a variety of reward accounts and offers available when making payments. Some of these rewards include rewards for certain types of payments. For example, a particular account may offer rewards for transactions with certain sellers or types of sellers, transactions on certain dates or at certain times, transactions over a certain amount, other types of transactions, or various combinations thereof. In addition to having various types of payments trigger these rewards, payment options may offer different types of rewards, and these rewards may vary depending on the type of transaction. For example, payment options may offer various combinations of cash back, flight discounts, promotional offers, or other types of rewards. Identifying which account and/or offer to utilize may present a challenge to both customers and merchants.

### SUMMARY OF THE DISCLOSURE

In accordance with the present invention, certain disadvantages and problems associated with reward decisions may be reduced or eliminated.

According to one embodiment, a plurality of reward parameters are received by an interface, each reward parameter associated with a user account of a user, and the plurality of reward parameters are stored by a memory. The interface receives information associated with a seller. A processor then automatically selects a user account based on the plurality of reward parameters and the information associated with the seller, and the interface communicates information indicating the selected user account.

According to another embodiment, a plurality of reward parameters are received by an interface, each reward parameter associated with a user account of a user, and the plurality of reward parameters are stored by a memory. The interface receives information associated with a seller promotion, and the information associated with the seller promotion is stored by the memory. The interface then receives information associated with a location of the user. In response to the information associated with the location of the user, a processor automatically determines a promotion response based at least on the plurality of reward parameters and the information associated with the seller promotion. The interface then communicates the promotion response.

Certain embodiments of the invention may provide one or more technical advantages. A technical advantage of one embodiment may provide improved maximization or rewards from payments by facilitating automatic calculations of various reward parameters, available offers, and other factors in selecting the optimal user account for a payment. Another technical advantage of an embodiment allows for improved customer experiences by automatically selecting a reward account for the customer, who may have numerous reward accounts with complicated conditions and other factors affecting the rewards received. Certain embodiments may also allow for faster checkout processing since the optimal payment choice can be selected and primed before the user begins checkout. Furthermore, some embodiments may provide an efficient mechanism for sellers to identify and market to potential customers. Certain embodiments may also allow sellers to more effectively market their products or services and offer promotions by allowing sellers to target their promotions to more receptive customers and provide promotions that are more closely tailored to the customers' interests.

Certain embodiments of the invention may include none, some, or all of the above technical advantages. One or more other technical advantages may be readily apparent to one skilled in the art from the figures, descriptions, and claims included herein.

### BRIEF DESCRIPTION OF THE DRAWINGS

For a more complete understanding of the present invention and its features and advantages, reference is now made to the following description, taken in conjunction with the accompanying drawings, in which:

FIG. 1 illustrates an example system that facilitates reward decisions;

FIG. 2 illustrates example user information used by a reward module;

FIG. 3 illustrates example seller information used by a reward module; and

FIG. 4 illustrates an example reward decision sequence.

### DETAILED DESCRIPTION OF THE DRAWINGS

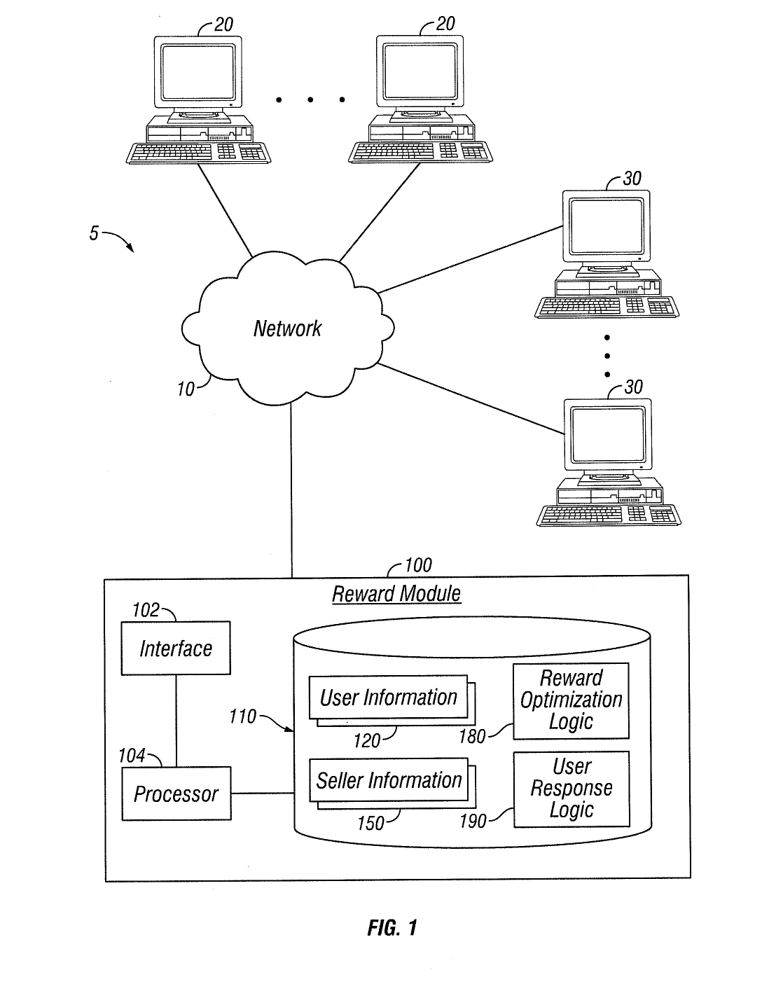

Embodiments of the present invention and its advantages are best understood by referring to FIGS. 1 through 4, like numerals being used for like and corresponding parts of the various drawings.

FIG. 1 illustrates an example system 5 that facilitates reward decisions. System 5 includes reward module 100, which communicates with one or more user devices 20 and one or more workstations 30 over network 10. Reward module 100 includes processor 104, which is communicatively coupled to network interface 102, and memory 110. Memory 110 includes user information 120, seller information 150, reward optimization logic 180, and user response logic 190.

Reward module 100 facilitates the selection of reward accounts. Reward parameters, each reward parameter associated with a user account of a user, are communicated from user device 20 to reward module 100 over network 10 and stored in memory 110. For example, a user may have multiple reward credit card accounts, each account having different rewards for different types of purchases, and reward module 100 may receive and store information associated with these rewards. Reward module 100 may also receive and store user preferences indicating a preference for certain types of rewards or other preferences. Reward module 100 later receives information indicating one or more sellers from which the user may make a purchase. For example, reward module 100 may receive information indicating that the user is near or shopping at a particular store, that the user is interacting with a particular website, or that the user is viewing or purchasing particular products. Based on this information, along with the stored reward parameters and, optionally, the user preferences, reward module 100 automatically selects a user account that the user may use during the current or prospective transaction. This selection process may improve the user's ability to quickly and easily determine the optimal payment method for a particular purchase. Furthermore, making this selection based on the determination of the user's location may allow the optimal user account to be selected before the user begins the checkout process, which may improve the customer experience by reducing the delay in priming the selected user account for payment during the checkout process.

Reward module 100 also facilitates promotional offers. Having received and stored the reward parameters and, optionally, the user preferences, reward module 100 may also receive and store information associated with seller promotions. For example, a merchant may communicate information to reward module 100 related to various promotional offers or targeted customer types. When reward module 100 receives the information indicating the one or more sellers from which the user may make a purchase, as described above, reward module 100 may determine a promotion response based on the reward parameters, the information associated with the seller promotion, and, optionally, the user preferences. For example, reward module 100 may communicate information to the seller indicating a recommended promotional offer, an estimated likelihood of the user accepting a promotional offer, or information associated with one or more promotional offers previously offered to the user. This process may improve sellers' ability to quickly and easily identify promotional offers that can be made to customers or potential customers. This process may also facilitate the provision of valuable information about potential customers' likely responsiveness to various promotions, allowing sellers to make more informed marketing decisions. Furthermore, since the facilitation of promotional offers can be based on the determination of the user's location, the selection and presentation of promotional offers associated with the reward parameters can be performed prior to checkout and, potentially, before the customer has entered the store. Enabling this pre-checkout processing may improve the ability of the sellers to attract additional customers and to efficiently elicit a greater number of purchases via targeted promotional offers.

According to the illustrated embodiment, system 5 includes user devices 20 that communicate with reward module 100 through network 10. User devices 20 may include one or more laptops, personal computers, monitors, display devices, handheld devices, tablet computers, landline phones, smartphones, smart chip cards, biometric sensor devices, servers, user input devices, or any other suitable component for enabling the communication of standards information. User devices 20 may also include devices owned, operated, managed, and/or housed partially or wholly by another entity, such as a company with which a user has an account. Furthermore, multiple devices and types of user devices 20 can operate together to perform the functions described herein. For example, reward parameters and user preferences may be received from a user's smartphone, while a user's location and/or payment is processed by a biometric sensor device (such as an iris scanner, DNA scanner, voice analyzer, thumb print reader, or any other biometric sensor device).

User devices 20 communicate rewards information, location information, and other information associated with the user to reward module 100. For example, a server may be used to submit rewards parameters (such as, for example, one or more user accounts or rewards information associated with such accounts) and user preferences to reward module 100 through network 10, enabling reward module 100 to utilize these reward parameters and user preferences when automatically determining which user account the customer should use when making a purchase. These reward parameters and user preferences may also enable reward module 100 to automatically determine a promotion response for a seller that is seeking to select a promotion for a particular user. Such promotions may include promotional offers (temporary or otherwise), various types of advertisements, or any other suitable promotion. As another example, a mobile device may be used to communicate location information or other information enabling the identification of one or more nearby merchants. This information may enable reward module 100 to evaluate different reward options available to the user for a seller with whom the user is currently engaged in a transaction, evaluate rewards options available at nearby merchants, and communicate with sellers to facilitate promotions for the user.

Workstations 30 enable one or more users to monitor, administer, or otherwise interact with reward module 100 through network 10. Workstations 30 may include one or more laptops, personal computers, monitors, display devices, handheld devices, smartphones, servers, user input devices, or other suitable components for enabling the sending and/or receiving of communications through network 10. Workstations 30 enable a seller to communicate information regarding one or more seller promotions to reward module 100 and receive a promotion response from reward module 100. For example, a seller may use a workstation 30 to communicate information associated with a seller promotion, such as information associated with one or more promotional offers, one or more targeted customers, or one or more types of targeted customers. Workstations 30 also allow sellers to receive communications from reward module 100, such as a promotion response, which can include a promotional offer, an estimated likelihood of a user accepting a promotional offer, information associated with one or more promotional offers previously offered to the user, or any other communications from reward module 100.

Network 10 represents any suitable network operable to facilitate communication between the components of system 5. Network 10 may include any interconnecting system capable of transmitting audio, video, signals, data, messages, or any combination of the preceding. Network 10 may include all or a portion of a public switched telephone network (PSTN), a public or private data network, a local area network (LAN), a metropolitan area network (MAN), a wide area network (WAN), a local, regional, or global communication or computer network such as the Internet, a wireline or wireless network, an enterprise intranet, or any other suitable communication link, including combinations thereof operable to facilitate communication between the components.

Reward module 100 represents any suitable components that facilitate the evaluation of payment choices or promotional offers. Reward module 100 may include a network server, remote server, mainframe, host computer, workstation, web server, personal computer, file server, or any other suitable device operable to process data and communicate with user devices 20 and/or workstations 30. In some embodiments, reward module 100 may execute any suitable operating system such as IBM's zSeries/Operating System (z/OS), MS-DOS, PC-DOS, MAC-OS, WINDOWS, UNIX, OpenVMS, Linux or any other appropriate operating systems, including future operating systems. The functions of reward module 100 may be performed by any suitable combination of one or more servers or other components at one or more locations. In the embodiment where the modules are servers, the servers may be public or private servers, and each server may be a virtual or physical server. The server may include one or more servers at the same or at remote locations. Reward module 100 may also include any suitable component that functions as a server. In some embodiments, user device 20 and/or workstation 30 may be integrated with reward module 100, or they may operate as part of the same device or devices.

In the illustrated embodiment, reward module 100 includes network interface 102, processor 104, and memory 110.

Network interface 102 represents any suitable device operable to receive information from network 10, transmit information through network 10, perform suitable processing of the information, communicate to other devices, or any combination thereof. For example, network interface 102 receives, from user devices 20, a plurality of reward parameters and information associated with a seller. In some embodiments, network interface 102 receives information indicating a preference of a user. In certain embodiments, network interface 102 also receives, from workstation 30, information associated with a seller, such as information associated with one or more promotional offers, one or more targeted customers, or one or more types of targeted customers. Network interface 102 is also configured to communicate information to user devices 20 and/or workstations 30. For example, network interface 102 may communicate information indicating the user account selected by reward module 100. Network interface 102 may also communicate a promotion response, which may include a promotional offer, an estimated likelihood of a user accepting a promotional offer, information associated with one or more promotional offers previously offered to the user, and/or other responses associated with promotions or marketing for the user. Network interface 102 represents any port or connection, real or virtual, including any suitable hardware and/or software, including protocol conversion and data processing capabilities, to communicate through a LAN, WAN, or other communication system that allows reward module 100 to exchange information with network 10, user devices 20, workstations 30, other reward modules 100, or other components of system 5.

Processor 104 communicatively couples to network interface 102 and memory 110, and controls the operation and administration of reward module 100 by processing information received from network interface 102 and memory 110. Processor 104 includes any hardware and/or software that operates to control and process information. For example, processor 104 executes reward optimization logic 180 to control the selection of user accounts that the user may use to make a purchase and executes user response logic 190 to control the determination of the appropriate promotion response for the seller. Processor 104 may be a programmable logic device, a microcontroller, a microprocessor, any suitable processing device, or any suitable combination of the preceding.

Memory 110 stores, either permanently or temporarily, data, operational software, or other information for processor 104, other components of reward module 100, or other components of system 5. Memory 110 includes any one or a combination of volatile or nonvolatile local or remote devices suitable for storing information. For example, memory 110 may include random access memory (RAM), read only memory (ROM), flash memory, magnetic storage devices, optical storage devices, network storage devices, cloud storage devices, solid state devices, or any other suitable information storage device or a combination of these devices. While illustrated as including particular modules, memory 110 may include any suitable information for use in the operation of reward module 100. In the illustrated embodiment, memory 110 includes user information 120, seller information 150, reward optimization logic 180, and user response logic 190. Any of these components may be distributed and/or duplicated across multiple memory devices in reward module 100 or in other devices.

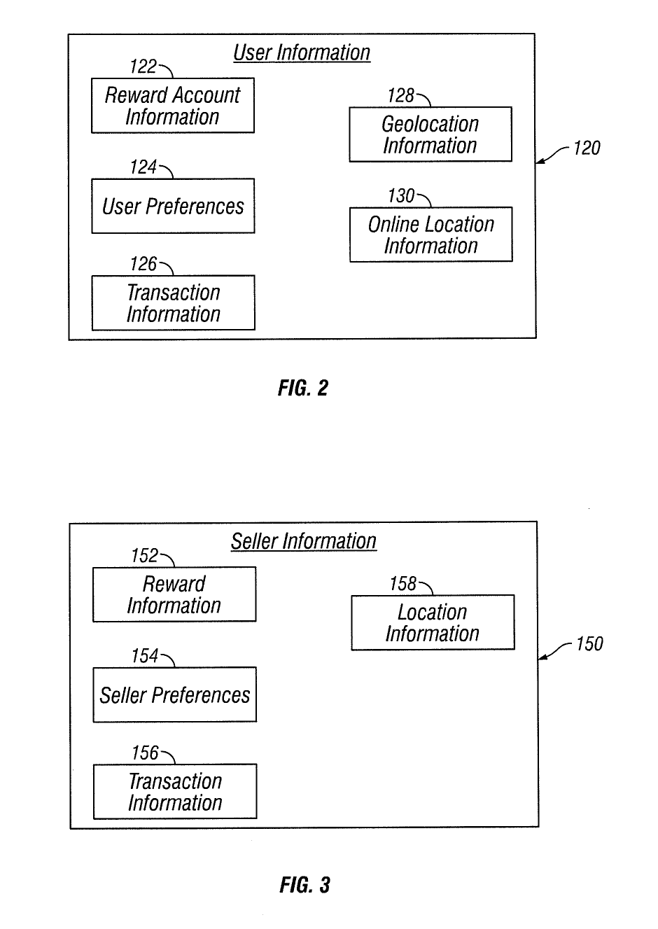

User information 120 represents any suitable information associated with one or more users. Reward module 100 may evaluate payment choices and promotion responses based on user information 120. User information 120 may include information associated with one or more users and may be stored in a relational database, tree structure, or any other suitable data structure. User information 120 is discussed in more detail below in reference to FIG. 2.

Seller information 150 represents any suitable information associated with one or more sellers. Reward module 100 may evaluate payment choices and promotion responses based on seller information 150. Seller information 150 may include information associated with one or more sellers and may be stored in a relational database, tree structure, or any other suitable data structure. Seller information 150 is discussed in more detail below in reference to FIG. 3.

Reward optimization logic 180 represents any suitable set of instructions, logic, or code embodied in a computer-readable storage medium and operable to facilitate the selection of user accounts that the user may use to make a purchase. Reward optimization logic 180 may be stored in memory 110 or another memory associated with reward module 100. Reward optimization logic 180, or portions thereof, may also be embodied in hardware associated with reward module 100 or other components of system 5. Furthermore, the components of reward optimization logic 180 may be stored in the same or different memories of the same or different reward modules 100. Various components of reward optimization logic 180 may also be stored in different components of system 5.

In operation, reward optimization logic 180 evaluates reward parameters, location information, user preferences, seller information, promotion information, transaction history, and/or any other suitable information in order to select a user account for use in a current or prospective payment. For example, reward optimization logic 180 may analyze the reward parameters, each of which is associated with a user account (such as, for example, a reward credit card, frequent flyer account, gas card, gift card, membership account, flex spending account, or any other account associated with discounts, bonuses, or other rewards), user preferences (such as a preference for cash back or for airline miles), seller information (such as sellers located near the user, promotions available from such sellers, a particular seller selected by the user, a seller website visited by the user, or other seller information), and/or other information (such as the user's closeness to receiving a reward threshold for a particular user account, the timing of a particular reward, or other suitable information for facilitating the selection of an optimal user account) in order to select a user account. Reward optimization logic 180 may then facilitate the communication of the selected user account to user device 20. This analysis may allow users to quickly, effectively, and conveniently determine a desired payment option and/or other available user account (such as a gift card or discount-giving membership) from multiple available options. Embodiments in which the selected user account is automatically activated in an electronic payment application may also provide a streamlined and convenient way to prime the optimal payment option during checkout.

The operation of reward optimization logic 180 may be triggered by various events. In some embodiments, reward optimization logic 180 operates to select a user account following a request by the user. In other embodiments, reward optimization logic 180 operates to select a user account following the receipt of information indicating the customer's location. For example, operation of reward optimization logic 180 may be triggered by the receipt of information indicating that a user is located in or near a seller's store. As another example, operation of reward optimization logic 180 may be triggered by the receipt of information from the user or seller that a user is viewing the seller's website, triggering the operation of user response logic 190. Triggering the operation of reward optimization logic 180 before checkout in this manner may reduce the need to perform such analysis while the user waits at the point of sale.

User response logic 190 represents any suitable set of instructions, logic, or code embodied in a computer-readable storage medium and operable to facilitate the determination of the appropriate promotion response for the seller. User response logic 190 may be stored in memory 110 or another memory associated with reward module 100. User response logic 190, or portions thereof, may also be embodied in hardware associated with reward module 100 or other components of system 5. Furthermore, the components of user response logic 190 may be stored in the same or different memories of the same or different reward modules 100. Various components of user response logic 190 may also be stored in different components of system 5.

In operation, user response logic 190 evaluates reward parameters, location information, user preferences, seller information, promotion information, transaction history, and/or any other suitable information in order to determine a promotion response to provide the seller. User response logic 190 may analyze user information 120 and seller information 130 to suggest promotional offers or provide estimations of the likely success of one or more promotions with respect to a customer. For example, user response logic 190 may analyze the rewards offered by various user accounts of a user that is determined to be in or near a seller location, preferences indicated by the user, information associated with the user's previous transactions, or other information to determine a promotion response. This promotion response may be a suggested promotional offer, an estimated likelihood of a user accepting a promotional offer, information associated with one or more promotional offers previously offered to the user, or another recommendation or piece of information associated with promotions or marketing. As a particular example, user response logic 190 may analyze user information 120 and determine, based on the user's possession of a frequent flyer reward credit card and a user preference for frequent flyer mile rewards, that the optimal promotion is a frequent flyer mile bonus offer. The promotion response in this case may be a recommendation to offer a double miles promotion to the customer. In another example, user response logic 190 may analyze user information 120 and determine, based on the user's cash back reward cards and the user's previous acceptance of cash back reward promotional offers, that the optimal promotion is a cash back offer. The promotion response in this case may be a recommendation to offer a cash back promotion to the customer.

The promotion response determined by the operation of user response logic 190 may be used in different ways. In some embodiments, user response logic 190 may operate to communicate promotional offers to the sellers, which can then choose to communicate a promotion offer to the user themselves. In other embodiments, user response logic 190 may operate to communicate the selected promotional offer directly to the customer. In still other embodiments, user response logic 190 may communicate the promotion response to the seller and then receive additional communications from the seller indicating which promotion the seller would like reward module 100 to communicate to the customer.

The operation of user response logic 190 may be triggered by various events. In some embodiments, user response logic 190 operates to determine a promotion response following a request by the seller or the customer. In other embodiments, user response logic 190 operates to determine the promotion response following the receipt of information indicating the customer's location. For example, reward module 100 may receive information indicating that a user is located in or near a seller's store, triggering the operation of user response logic 190. As another example, reward module 100 may receive information from the seller that a user is viewing the seller's website, triggering the operation of user response logic 190. Triggering the operation of user response logic 190 before checkout improves the ability of the seller to provide effective promotions to potential customers who may be receptive to certain types of offers.

In an exemplary embodiment of operation, user device 20 communicates a plurality of reward parameters to reward module 100, which stores the rewards information in memory 110. Reward module 100 then receives information indicating the user's association with a seller (such as physical proximity to a seller, an indication that the user is in the process of making a purchase from the seller, or an indication that user is interacting with the seller's website or mobile application), triggering the execution of reward optimization logic 180. Reward optimization logic 180 evaluates reward parameters, location information, user preferences, seller information, promotion information, transaction history, and/or any other suitable information in order to select a user account for use in a current or prospective payment, and the selected user account is communicated to the user.

In another exemplary embodiment of operation, user device 20 communicates a plurality of reward parameters to reward module 100, which stores the rewards information in memory 110. Reward module 100 also receives information from the seller regarding its promotions. Reward module 100 then receives information indicating the user's association with a seller (such as physical proximity to a seller, an indication that the user is in the process of making a purchase from the seller, or an indication that user is interacting with the seller's website or mobile application), triggering the execution of user response logic 190. User response logic 190 evaluates reward parameters, location information, user preferences, seller information, promotion information, transaction history, and/or any other suitable information in order to determine a promotion response, and this promotion response is then communicated to the seller or the customer.

A component of system 5 may include an interface, logic, memory, and/or other suitable element. An interface receives input, sends output, processes the input and/or output, and/or performs other suitable operations. An interface may comprise hardware and/or software. Logic performs the operation of the component. For example, logic executes instructions to generate output from input. Logic may include hardware, software, and/or other logic. Logic may be encoded in one or more non-transitory, tangible media, such as a computer readable medium or any other suitable tangible medium, and may perform operations when executed by a computer. Certain logic, such as a processor, may manage the operation of a component. Examples of a processor include one or more computers, one or more microprocessors, one or more applications, and/or other logic.

Modifications, additions, or omissions may be made to system 5 without departing from the scope of the invention. For example, system 5 may implement reward optimization procedures different from or in addition to those described herein. As another example, multiple reward modules 100 may operate in parallel to facilitate reward optimization or promotions. System 5 may include any number of user devices 20, networks 10, reward modules 100, and workstations 30. Any suitable logic may perform the functions of system 5 and the components within system 5.

FIG. 2 illustrates example user information 120, which includes reward account information 122, user preferences 124, transaction information 126, geolocation information 128, and online location information 130. Various embodiments may include some, all, or none of these components. Reward module 100 may obtain this information via different types of graphical user interfaces (“GUIs”), web applications, or any other suitable means for obtaining information.

Reward account information 122 includes reward information associated with user accounts. Users may have numerous types of accounts that offer rewards. For example, users may have reward credit cards, frequent flyer accounts, gas cards, gift cards, membership accounts, flex spending accounts, or other accounts associated with discounts, bonuses, or other rewards. Each aspect of each reward may be a reward parameter that is stored as part of reward account information 122. User accounts may have different types of rewards, such as various cash back percentages, fixed cash back amounts, airline miles or points, discounts, progress toward various benefits, or any other suitable reward types. These accounts may also have various means of determining the amount of the reward. For example, some rewards may offer a certain percentage cash back for one type of purchase and a different percentage cash back for another type of purchase. Other rewards may offer increased rewards during certain time periods. Still other rewards may offer staggered bonuses, such that, for example, a reward might be received after reaching a threshold amount of purchases. User accounts may also have various limits. For example, some user accounts may cap the amount of a certain reward that can be received within a certain amount of time, and other accounts may restrict the accumulation (or spending) of rewards during certain time periods. Furthermore, user accounts may have multiple types of rewards that are triggered under different circumstances. For example, an example reward credit card may offer cash back on certain types of purchases and bonus miles on other types of purchases. Numerous types, combinations, and organizations of these reward parameters are possible. Reward account information 122 provides a basis for the calculations of reward optimization logic 180 in identifying which account or combination of accounts provides optimal rewards for a particular purchase. Reward account information 122 may also be used by user response logic 190 so that sellers can leverage the customers' existing reward accounts in utilizing promotions or other marketing.

In some embodiments, reward account information 122 may include information regarding accounts that allow users to engage in non-monetary transactions, in which rewards are offered for non-monetary actions by the user and/or non-monetary rewards are offered for actions by the user. As an example of non-monetary actions that can be taken by a user to elicit rewards, certain social web applications allow users to “check in” to seller locations or otherwise provide an indication via social media that the user is interacting with or approves of the seller. Sellers may offer a reward, discount, or other promotion if a user takes one or more of these non-monetary actions. As a particular example, a seller may offer double airline miles to shoppers who communicate approval of the seller via a social media account. In such embodiments, reward account information 122 may include information indicating a user's affiliation with social media or other accounts that enable non-monetary actions for which the seller can offer a reward. This information may simply indicate a user's possession of such an account, or it may include information identifying the specific rewards that are associated with the non-monetary actions. Incorporating rewards for non-monetary transactions into its analysis may enable reward module 100 to more effectively maximize a user's rewards by identifying additional reward-generating actions that a user can take beyond purchases. Furthermore, the rewards themselves may be non-monetary. For example, sellers may offer virtual badges or other non-monetary rewards for certain behavior by a user. In some embodiments, one or more of these non-monetary rewards may be converted into or redeemed for another reward (such as points, cash, airline miles, gifts, or any other type of reward). Incorporating non-monetary rewards into its analysis may enable reward module 100 to improve its reward suggestions by identifying additional, non-monetary rewards that users may find valuable.

User preferences 124 include information indicating a reward preference of a user. For example, users may indicate that cash back rewards are preferred over airline miles or that gift cards should be exhausted before other accounts are utilized under certain conditions. User preferences 124 may indicate binary or absolute preferences, or they may indicate weighted or conditional preferences. For example, in one embodiment, a user may indicate that airline miles rewards are always preferred, while in another embodiment, a user may indicate that airline miles are preferred under certain conditions, while cash back is preferred under other conditions. In some embodiments, users may express preference via ranking, scoring, or other measures of preference. In still other embodiments, users may express preferences to a third party who organizes and inputs user preferences 124 for the user. Numerous types, combinations, and organizations of user preferences 124 are possible. User preferences 124 may be used by reward optimization logic 180 to select user accounts so that the rewards generated by a payment are better in line with the user's desired outcome. User preferences 124 may also be used by user response logic 190 so that promotions offered by sellers can be more effectively tailored to customers' interests.

Transaction information 126 includes information associated with users' previous transactions. For example, transaction information 126 may include information about which promotional offers by sellers a user has previously accepted. Transaction information 126 may also include information about what types of purchases users have made and what reward accounts have been utilized. Transaction information 126 may be utilized by reward optimization logic 180 to better predict a reward account that the user is more likely to prefer, since the user's past behavior may convey implicit preferences. Transaction information 126 may also be used by user response logic 190 to improve the recommended promotion by incorporating the customers' past behavior into the analysis.

Geolocation information 128 includes information associated with a user's physical location. For example, reward module 100 may receive information from a user indicating the location that reward module 100 can use to determine the user's proximity to one or more store locations. Reward module 100 may also receive information directly indicating a user's proximity to, or presence at, one or more store locations. For example, user device 20 may utilize a GPS application to determine its location and communicate that location to reward module 100, or user device 20 may utilize a GPS application to determine its proximity to one or more store locations and then communicate these store locations to reward module 100. In a particular example, reward module 100 may receive information indicating that a user is engaging in, or may engage in, a transaction with a particular seller. Geolocation information 128 may provide a trigger to execute reward optimization logic 180 and/or user response logic 190 for a particular user and seller. Geolocation information 128 may also allow reward module 100 to improve the customer experience by facilitating the preloading of user account selections before the point of sale. Geolocation information 128 may also allow sellers to target promotions to nearby customers who might not otherwise make a purchase at the store, and it may improve the sellers' ability to generate increased sales by offering promotions to customers who are still in the process of shopping and have not yet begun checking out.

Online location information 130 includes information associated with a user's interaction with one or more websites, mobile applications, or other online-based interfaces. For example, online location information 130 may include information indicating a website that a user is currently visiting. Online location information 130 may also include information indicating online locations that a user has visited in the past or is likely to visit in the future. As a particular example, a merchant website may communicate information to reward module 100 indicating that a particular user has selected a product or service for potential purchase or rental on a website, enabling the determination of targeted promotions. Online location information 130 may provide a trigger to execute reward optimization logic 180 and/or user response logic 190 for a particular user and seller. Online location information 130 may also allow reward module 100 to improve the customer experience by facilitating the preloading of user account selections before the point of sale. Online location information 130 may also allow sellers to target promotions to customers who might not otherwise make a purchase from the website or mobile application, and it may improve the sellers' ability to generate increased sales by offering promotions to customers who are still in the process of shopping and have not yet begun checking out.

FIG. 3 illustrates example seller information 130, which includes reward information 152, seller preferences 154, transaction information 156, and location information 158. Various embodiments may include some, all, or none of these components.

Reward information 152 includes information associated with one or more available reward or promotion offers potentially available from a seller. For example, reward information 152 may indicate that a particular seller has the option of offering double airline miles to certain customers under certain conditions. As another example, reward information 152 may include information indicating that a seller is offering a particular promotion for certain period of time. Reward information 152 enables reward module 100 to determine what promotions may be available to a user when selecting a user account for the user. For example, reward module 100 may analyze reward information 152 and determine that the store in which a user is shopping is offering double airline miles on all purchases. Based on this information, reward module 100 may select the user's frequent flyer reward credit card when the user makes the purchase in order to maximize the user's rewards. Reward information 152 may also provide a basis for user response logic 190 to determine the promotion response, since reward information 152 may include the available rewards and promotions that the seller is willing to offer. Reward information 152 may thus improve both the selection of the optimal user account for the customer as well as the determination of the optimal promotional offer for the seller.

In some embodiments, reward information 152 may include information regarding non-monetary transactions in which rewards are offered for non-monetary actions by the user and/or non-monetary rewards are offered for actions by the user. As an example of non-monetary actions that can be taken by a user to elicit rewards, certain social web applications allow users to “check in” to seller locations or otherwise provide an indication via social media that the user is interacting with or approves of the seller. Sellers may offer a reward, discount, or other promotion if a user engages in one or more of these non-monetary actions. As a particular example, a seller may offer a 5% discount to shoppers who communicate approval of the seller via a social media account. In such embodiments, reward information 152 may include information indicating rewards that may be offered to customers for non-monetary actions. Incorporating such information into its analysis may enable reward module 100 to provide more effective promotion suggestions by allowing sellers to target and attract customers with rewards for non-monetary actions, which users may be more inclined to take. Furthermore, the rewards themselves may be non-monetary. For example, sellers may offer virtual badges or other non-monetary rewards for certain behavior by a user. In some embodiments, one or more of these non-monetary rewards may be converted into or redeemed for another reward (such as points, cash, airline miles, or any other type of reward). Incorporating non-monetary rewards into its analysis may enable reward module 100 to provide more effective promotion suggestions, since it may identify promotions that sellers can offer at little or no cost.

Seller preferences 154 include information indicating a seller's preferences with respect to rewards or promotions. These preferences include one or more targeted customers, one or more types of targeted customers, conditions or rules for notifying the seller of a nearby customer, or any other preferences associated with offering promotions or other marketing. Seller preferences 154 may indicate binary or absolute preferences, or they may indicate weighted or conditional preferences. For example, in one embodiment, a seller may indicate that it wants to be informed of all users that are within a certain distance of a particular store location, while another seller may indicate that it wants to be informed of certain types of customers near the store location under certain conditions. In some embodiments, sellers may express preference via ranking, scoring, or other measures of preference. In still other embodiments, sellers may express preferences to a third party who organizes and inputs seller preferences 154 for the seller. Numerous types, combinations, and organizations of user preferences 124 are possible.

Transaction information 156 includes information associated with a seller's past, current, or future transactions with customers. Transaction information 156 may include information indicating which types of promotions or marketing has been successful in the past, which customers or types of customers have been successfully solicited, or any other information associated with the seller's transactions. Numerous types, combinations, and organizations of transaction information 156 are possible. Transaction information 156 may enable reward module 100 to provide more effective promotion recommendations to sellers. Transaction information 156 may also improve predictions made by reward module 100 regarding the likelihood that a particular promotional offer or marketing communication will be successful.

Location information 158 includes information associated with the location of a seller. For example, location information 158 may indicate a seller's geographic location so that a user's proximity to the store location can be determined. Location information 158 may also include information about a seller's online location, such as URLs or IP address information. Location information 158 facilitates the efficient and user-friendly determination of when users are at or near a particular seller location. This information also allows reward module 100 to provide promotion recommendations to sellers for nearby customers or potential customers.

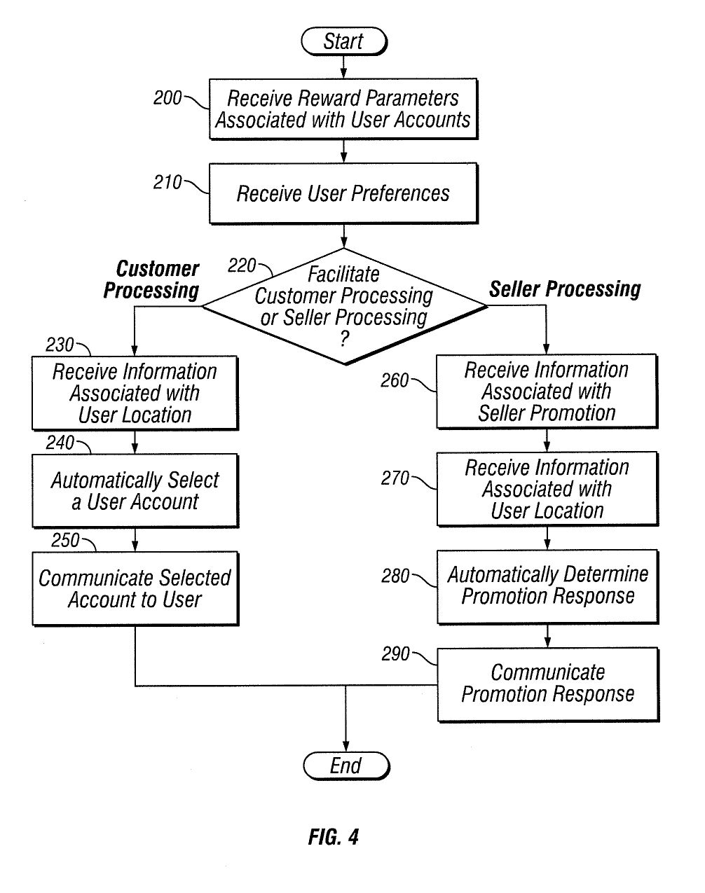

FIG. 4 illustrates an example reward decision sequence that facilitates the selection of one or more reward accounts for customers and the determination of promotions responses for sellers.

At step 200, reward module 100 receives reward parameters associated with one or more user accounts. Users may have various user accounts that can be used with payments such as reward credit cards, frequent flyer accounts, gas cards, gift cards, membership accounts, flex spending accounts, or other accounts associated with discounts, bonuses, or other rewards. Each aspect of each reward may be a reward parameter that is stored by reward module 100. User accounts may have different types of rewards, such as various cash back percentages, fixed cash back amounts, airline miles or points, discounts, progress toward various benefits, or any other suitable reward types. These accounts may also have various means of determining the amount of the reward. For example, some rewards may offer a certain percentage cash back for one type of purchase and a different percentage cash back for another type of purchase. Other rewards may offer increased rewards during certain time periods. User accounts may have multiple types of rewards that are triggered under different circumstances. For example, an example reward credit card may offer cash back on certain types of purchases and bonus miles on other types of purchases. These reward parameters provide a basis for the selection of a user account during step 240. Receiving and storing reward parameters allows reward module 100 to leverage the customers' existing reward accounts in selecting promotions or other marketing recommendations during step 280.

At step 210, reward module 100 receives user preferences associated with payment rewards. For example, users may indicate that cash back rewards are preferred over airline miles or that gift cards should be exhausted before other accounts are utilized under certain conditions. In some embodiments, users may express preference via ranking, scoring, or other measures of preference. In other embodiments, users may express preferences to a third party who organizes and inputs user preferences 124 for the user. These preferences may be used by reward module 100 to select user accounts during step 240 so that the rewards generated by a payment are better in line with the user's desired outcome. These preferences may also be used by reward module 100 so that the promotion response identified in step 280 can be more effectively tailored to customers' preferences.

At step 220, reward module 100 may determine whether to perform steps associated with customer processing or seller processing. For example, having received information about a user's reward accounts and reward preferences in previous steps, reward module 100 may prepare itself to receive a user's location, which may trigger the execution of reward optimization logic 180. Reward module 100 may also determine that sufficient information has been received to begin the calculations necessary to provide promotion recommendations for a seller. A reward module 100 may performs steps associated with both customer processing and seller processing, or some reward modules 100 may handle one or more aspects of customer processing while other reward modules 100 handle one or more aspects of seller processing. Furthermore, customer and seller processing may be performed concurrently by the same reward module 100. The determination at step 220 may be made by dynamic processes executed by reward module 100, by configuration by an administrator of reward module 100, or by other suitable means. Upon determining that it will facilitate customer processing, reward module 100 proceeds to step 230. Upon determining that it will facilitate seller processing, reward module 100 proceeds to step 260.

At step 230, reward module 100 receives information associated with a user's location. For example, reward module 100 may receive information from a user indicating the user's location, which reward module 100 can use to determine the user's proximity to one or more store locations. Reward module may also receive information directly indicating a user's proximity to, or presence at, one or more store locations. For example, user device 20 may utilize a GPS application to determine its location and communicate that location to reward module 100, or user device 20 may utilize a GPS application to determine its proximity to one or more store locations and then communicate these store locations to reward module 100. In a particular example, reward module 100 may receive information indicating that a user is engaging in, or may engage in, a transaction with a particular seller. Reward module 100 may also receive information indicating a user's interaction with website, mobile application, or other online interface. The location information received at step 230 may provide a trigger to execute reward optimization logic 180 for a particular user and seller, prompting reward module 100 to proceed to step 240. This information may allow reward module 100 to improve the customer experience by facilitating the preloading of user account selections before the point of sale.

At step 240, reward module 100 selects a user account with which the user may make a payment. For example, reward optimization logic 180 may analyze the reward parameters received during step 200, each of which is associated with a user account (such as, for example, a reward credit card, frequent flyer account, gas card, gift card, membership account, flex spending account, or any other account associated with discounts, bonuses, or other rewards), user preferences received during step 210 (such as a preference for cash back or for airline miles), seller information (such as sellers located near the user, promotions available from such sellers, a particular seller selected by the user, a seller website visited by the user, or other seller information), and/or other information (such as the user's closeness to receiving a reward threshold for a particular user account, the timing of a particular reward, or other suitable information for facilitating the selection of an optimal user account) in order to select a user account. This analysis may allow users to quickly, effectively, and conveniently determine a desired payment option and/or other available user account from multiple available options. This selection may also incorporate factors (such as, for example, special promotions available from the seller or the user's closeness to reaching a certain reward threshold or limit) that may not be readily apparent to the user. The selection process of step 240 may thus allow users to more effectively maximize their rewards from various payments.

At step 250, reward module 100 communicates the select account to the user. This communication may simply be a recommendation to the user, or it may trigger additional processing by user device 20. In some embodiments, the communication of the selected account may trigger an automatic selection of the user account on user device 20. For example, user device 20 may run an electronic payment application associated with one or more user accounts, and the receipt of the selected user account by user device 20 may cause the application to automatically prepare the selected user account for use in the payment. In other embodiments, reward module 100 may only communicate a recommendation of a particular user account that the user may subsequently use or ignore. Reward module 100 may also communicate additional information, such as information indicating one or more reasons that the user account was selected. In still other embodiments, reward module 100 may communicate multiple user accounts along with information derived from the analysis. For example, reward module 100 may communicate the top two or three user accounts, and it may communicate a ranking or scoring of one or more user accounts based on the analysis of reward optimization logic 180. Embodiments in which the selected user account is automatically activated in an electronic payment application may provide a streamlined and convenient way to prime the optimal payment option during checkout.

At step 260, reward module 100 receives information associated with one or more seller promotions. This information may include reward or promotion information, preferences, information about previously offered promotions, or any other information associated with seller promotions. For example, reward module 100 may receive information from a workstation 30 indicating that a particular seller has the option of offering 5% cash back to certain types of customers. Receiving this information provides a basis for user response logic 190 to determine the promotion response during step 280, since reward information 152 may include the available rewards and promotions that the seller is willing to offer.

Reward module 100 may also receive seller preferences during step 260, such as one or more targeted customers, one or more types of targeted customers, conditions or rules for notifying the seller of a nearby customer, or any other preferences associated with offering promotions or other marketing. For example, in one embodiment, a seller may indicate that it wants to be informed of all users that are within a certain distance of a particular store location, while another seller may indicate that it wants to be informed of certain types of customers near the store location under certain conditions. These preferences may enable reward module 100 to provide more tailored recommendations for the seller.

Reward module 100 may also receive information associated with a seller's past, current, or future transactions with customers during step 260. Transaction information 156 may include information indicating which types of promotions or marketing has been successful in the past, which customers or types of customers have been successfully solicited, or any other information associated with the seller's transactions. This transactional information may enable reward module 100 to provide more effective promotion recommendations to sellers during step 280 by providing more data points from which to build a predictive model of customer responsiveness. Thus, receiving this type of information may improve predictions made by reward module 100 regarding the likelihood that a particular promotional offer or marketing communication will be successful.

At step 270, reward module 100 receives information associated with a user location. This receipt of location information proceeds similarly to the process described above with respect to step 230. Receiving this location information may provide a trigger to begin the calculations of step 280, which may simplify the promotion and marketing activities of sellers which may not need to actively monitor these user's locations themselves. This information also allows sellers to target promotions to nearby customers who might not otherwise make a purchase at the store, and it may improve the sellers' ability to generate increased sales by offering promotions to customers who are still in the process of shopping and have not yet begun checking out.

At step 280, reward module 100 automatically determines a promotion response for the seller. Reward module 100 may evaluate reward parameters, location information, user preferences, seller information, promotion information, transaction history, and/or any other suitable information in order to determine a promotion response to provide the seller. During this step, user response logic 190 may analyze user information 120 and seller information 130 to suggest promotional offers or provide estimations of the likely success of one or more promotions with respect to a customer. For example, user response logic 190 may analyze the rewards offered by various user accounts of a user that is determined to be in or near a seller location, preferences indicated by the user, information associated with the user's previous transactions, or other information to determine a promotion response. This promotion response may be a suggested promotional offer, an estimated likelihood of a user accepting a promotional offer, information associated with one or more promotional offers previously offered to the user, or another recommendation or piece of information associated with promotions or marketing. As a particular example, user response logic 190 may analyze user information 120 and determine, based on the user's possession of a cash back reward credit card and a user preference for cash back rewards, that the optimal promotion is a cash back bonus offer. The promotion response in this case may be a recommendation to offer a temporary cash back promotion to the customer. In another example, user response logic 190 may analyze user information 120 and determine, based on the user's club membership and the user's previous acceptance of promotional offers related to the club, that the optimal promotion is a targeted advertisement offering special discounts to club members.

At step 290, reward module 100 communicates the promotion response. In some embodiments, the promotion response may be communicated to the seller for further analysis and processing. In other embodiments, reward module 100 may communicate a promotion directly to the customer or potential customer. Furthermore, the promotion response may be used in different ways by the sellers. For example, in the club example described above, the seller may choose to send a targeted message (such as an email, text message, or other type of communication) directly to the customer. The seller may also decide, based on the promotion response from reward module 100, to present a dynamic advertisement at the store location or on a website or mobile application. Furthermore, in some embodiments, reward module 100 may communicate the promotion response to the seller and then receive additional communications from the seller indicating which promotion the seller would like reward module 100 to communicate to the customer.

Various embodiments may perform some, all, or none of the steps described above. For example, certain embodiments may omit step 210 under certain conditions, or they may omit this step entirely. Furthermore, certain embodiments may perform these steps in different orders or in parallel, and certain embodiments may also perform additional steps. While discussed as reward module 100 performing these steps, any suitable component of system 5 may perform one or more steps of the method.

Certain embodiments of the invention may provide one or more technical advantages. A technical advantage of one embodiment may provide improved maximization or rewards from payments by facilitating automatic calculations of various reward parameters, available offers, and other factors in selecting the optimal user account for a payment. Another technical advantage of an embodiment allows for improved customer experiences by automatically selecting a reward account for the customer, who may have numerous reward accounts with complicated conditions and other factors affecting the rewards received. Certain embodiments may also allow for faster checkout processing since the optimal payment choice can be selected and primed before the user begins checkout. Furthermore, some embodiments may provide an efficient mechanism for sellers to identify and market to potential customers. Certain embodiments may also allow sellers to more effectively market their products or services and offer promotions by allowing sellers to target their promotions to more receptive customers and provide promotions that are more closely tailored to the customers' interests.

Herein, “or” is inclusive and not exclusive, unless expressly indicated otherwise or indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, “A and B” means “A and B, jointly or severally,” unless expressly indicated otherwise or indicated otherwise by context.

Particular embodiments may be implemented as hardware, software, or a combination of hardware and software. As an example and not by way of limitation, one or more computer systems may execute particular logic or software to perform one or more steps of one or more processes described or illustrated herein. Software implementing particular embodiments may be written in any suitable programming language (which may be procedural or object oriented) or combination of programming languages, where appropriate. In various embodiments, software may be stored in computer-readable storage media. Any suitable type of computer system (such as a single- or multiple-processor computer system) or systems may execute software implementing particular embodiments, where appropriate. A general-purpose computer system may execute software implementing particular embodiments, where appropriate. In certain embodiments, portions of logic may be transmitted and or received by a component during the implementation of one or more functions.

Herein, reference to a computer-readable storage medium encompasses one or more non-transitory, tangible, computer-readable storage medium possessing structures. As an example and not by way of limitation, a computer-readable storage medium may include a semiconductor-based or other integrated circuit (IC) (such as, for example, an FPGA or an application-specific IC (ASIC)), a hard disk, an HDD, a hybrid hard drive (HHD), an optical disc, an optical disc drive (ODD), a magneto-optical disc, a magneto-medium, a solid-state drive (SSD), a RAM-drive, or another suitable computer-readable storage medium or a combination of two or more of these, where appropriate. Herein, reference to a computer-readable storage medium excludes any medium that is not eligible for patent protection under 35 U.S.C. §101. Herein, reference to a computer-readable storage medium excludes transitory forms of signal transmission (such as a propagating electrical or electromagnetic signal per se) to the extent that they are not eligible for patent protection under 35 U.S.C. §101. A computer-readable non-transitory storage medium may be volatile, non-volatile, or a combination of volatile and non-volatile, where appropriate.

This disclosure contemplates one or more computer-readable storage media implementing any suitable storage. In particular embodiments, a computer-readable storage medium implements one or more portions of interface 102, one or more portions of processor 104, one or more portions of memory 110, or a combination of these, where appropriate. In particular embodiments, a computer-readable storage medium implements RAM or ROM. In particular embodiments, a computer-readable storage medium implements volatile or persistent memory.

This disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. For example, various embodiments may perform all, some, or none of the steps described above. Various embodiments may also perform the functions described in various orders.

Various embodiments disclosed herein may be used together in a variety of combinations. In various embodiments, reward module 100 may have different types, numbers, and configurations of interface 102, processor 104, memory 110, or any components thereof. For example, various embodiments may include some, all, or none of the components of user information 120 shown in FIG. 2 or the seller information shown in FIG. 3. As another example, certain embodiments may include additional logic to facilitate the receiving and processing of information, the presentation of one or more GUIs, or post-transaction analysis.

Although the present invention has been described above in connection with several embodiments; changes, substitutions, variations, alterations, transformations, and modifications may be suggested to one skilled in the art, and it is intended that the present invention encompass such changes, substitutions, variations, alterations, transformations, and modifications as fall within the spirit and scope of the appended claims.

What is claimed is:

1. A method for evaluating reward choices, the method comprising:
receiving, by an interface, a plurality of reward parameters, each reward parameter associated with a user account of a user;
storing, by a memory, the plurality of reward parameters;
receiving, by the interface, information associated with a seller;
automatically selecting, by a processor, a user account based on the plurality of reward parameters and the information associated with the seller;
communicating, by the interface, information indicating the selected user account.

2. The method of claim 1, wherein the information associated with a seller comprises information associated with the location of the user.

3. The method of claim 1, further comprising receiving, by the interface, information indicating a preference of the user, the preference associated with at least one of the plurality of reward parameters, wherein automatically selecting the user account is based further on the preference of the user.

4. The method of claim 1, further comprising:
communicating to the seller, by the interface, user information comprising at least one of the following:
a location of the user;
the plurality of reward parameters;
information associated with a response to one or more promotional offers.

5. The method of claim 1, wherein automatically selecting the user account occurs prior to the user initiating a checkout process with the seller.

6. The method of claim 1, wherein at least one of the plurality of reward parameters is associated with a non-monetary transaction.

7. An apparatus for evaluating reward choices, the apparatus comprising:
an interface operable to:
receive a plurality of reward parameters, each reward parameter associated with a user account of a user;
receive information associated with a seller; and
communicate information indicating a selected user account.
a memory operable to store the plurality of reward parameters; and
a processor communicatively coupled to the interface and the memory, the processor operable to:
select a user account based on the plurality of reward parameters and the seller information.

8. The apparatus of claim 7, wherein the information associated with a seller is based on a location of the user.

9. The apparatus of claim 7, wherein the interface is further operable to receive information indicating a preference of the user, the preference associated with at least one of the plurality of reward parameters, wherein selecting the user account is based further on the preference of the user.

10. The apparatus of claim 7, wherein the interface is further operable to:
communicate user information to the seller, the user information comprising at least one of the following:
a location of the user;
the plurality of reward parameters;
information associated with a response to one or more promotional offers.

11. The apparatus of claim 7, wherein the processor is operable to select the user account prior to the user initiating a checkout process with the seller.

12. The apparatus of claim 7, wherein at least one of the plurality of reward parameters is associated with a non-monetary transaction.

13. A method for facilitating promotional offers by a seller, the method comprising:
receiving, by an interface, a plurality of reward parameters, each reward parameter associated with a user account of a user;
storing, by a memory, the plurality of reward parameters;
receiving, by the interface, information associated with a seller promotion;
storing, by the memory, the information associated with the seller promotion;
receiving, by the interface, information associated with a location of the user;
automatically determining, by the processor in response to receiving the information associated with the location of the user, a promotion response based at least on the plurality of reward parameters and the information associated with the seller promotion; and
communicating, by the interface, the promotion response.

14. The method of claim 13, wherein the information associated with seller promotions comprises at least one of the following:
information associated with one or more promotional offers;
one or more targeted customers; and
one or more targeted types of customers.

15. The method of claim 13, wherein the promotion response comprises at least one of the following:
a promotional offer;
an estimated likelihood of the user accepting a promotional offer; and
information associated with one or more promotional offers previously offered to the user.

16. The method of claim 13, further comprising receiving, by the interface, information indicating a preference of the user, wherein automatically determining the promotion response is based further on the information indicating the preference of the user.

17. The method of claim 13, wherein automatically determining the promotion response occurs prior to the user initiating a checkout process with the seller.

18. The method of claim 13, wherein the promotion response comprises an offer associated with a non-monetary transaction.

19. An apparatus for facilitating promotional offers by a seller, the apparatus comprising:
an interface operable to:
receive a plurality of reward parameters, each reward parameter associated with a user account of a user;
receive information associated with a seller promotion; and
communicate a promotion response.
a memory operable to:
store the plurality of reward parameters; and
store the information associated with the seller promotion; and
a processor communicatively coupled to the interface and the memory, the processor operable to:
automatically determine, in response to receiving the information associated with the location of the user, the promotion response based at least on the plurality of reward parameters and the information associated with the seller promotion.

20. The apparatus of claim 19, wherein the information associated with seller promotions comprises at least one of the following:
information associated with one or more promotional offers;
one or more targeted customers; and
one or more targeted types of customers.

21. The apparatus of claim 19, wherein the promotion response comprises at least one of the following:
a promotional offer;
an estimated likelihood of the user accepting a promotional offer; and
information associated with one or more promotional offers previously offered to the user.

22. The apparatus of claim 19, wherein:
the interface is further operable to receive information indicating a preference of the user; and
automatically determining the promotion response is based further on the information indicating the preference of the user.

23. The apparatus of claim 19, wherein the processor is operable to automatically determine the promotion response prior to the user initiating a checkout process with the seller.

24. The apparatus of claim 19, wherein the promotion response comprises an offer associated with a non-monetary transaction.
